(19) United States
(12) Patent Application Publication
(10) Pub. No.: US 2015/0358174 A1
(43) Pub. Date: Dec. 10, 2015

(54) METHOD AND SYSTEM OF PROVIDING A SET OF CONTROL PARAMETERS TO AN APPLIANCE FOR PROCESSING A CONSUMABLE PRODUCT

(71) Applicant: TOP ELECTRIC APPLIANCES INDUSTRIAL LTD., Guangshou, Guangdong (CN)

(72) Inventor: Weizhong Li, Guangzhou (CN)

(73) Assignee: TOP ELECTRIC APPLIANCES INDUSTRIAL LTD, Guangzhou, Guangdong (CN)

(21) Appl. No.: 14/436,365

(22) PCT Filed: Jun. 6, 2014
(86) PCT No.: PCT/CN2014/079419

§ 371 Date: Apr. 16, 2015

(51) Int. Cl. H04L 12/28; H04W 4/00; G05B 15/02

(52) U.S. Cl. CPC H04L 12/2816; G05B 15/02; H04W 4/008

(57) ABSTRACT

The invention provides a computer implemented method and system for providing a set of parameters, for example operational control parameters, to a domestic appliance for controlling operation of the appliance when processing a consumable product such as coffee, tea, wine, rice or the like. The method comprises uploading to a network based server from a third party entity such as a producer, supplier, distributor or seller of a consumable product an optimized or preferred set of one or more control parameters for processing the consumable product based on its identity and/or one or more specified characteristics of the product. The set of parameters is stored in a network storage device such as a database under control of the server. The set of parameters is stored in association with its identity and/or one or more specified characteristics. At a network connected appliance for processing a consumable product, the method includes receiving information identifying the consumable product and/or one or more characteristics of said consumable product. In response to receipt of said information at the appliance, the appliance is controlled to automatically send data over said network to said server. At the server, the data is processed to identify the consumable product and/or the identity of the one or more characteristics of said consumable product and, in response, to retrieve said stored set of one or more parameters from said network storage device and send them over said network to said appliance.

### TECHNICAL FIELD

The invention relates to a computer implemented method and system of providing a set of parameters, for example, operational control parameters, to a domestic appliance for processing a consumable product such as coffee, tea, wine, soup, rice or the like, although the invention is not limited to these types of consumable product and is not limited to providing only operational control parameters.

### BACKGROUND ART

Domestic appliances such as coffee makers, rice cookers, automatic wine decanters, soup boilers and tea makers or the like are often supplied with control instructions for operating the appliance efficiently. The control instructions may set out preferred or optimized sets of control parameters provided by the appliance manufacturer for processing a product, but may also allow a user to input their own preferred control parameters according to experience and taste.

One significant problem with such domestic appliances is that the above mentioned consumable products are complex products which vary widely in how they are best processed according to multiple factors including brand, type, quality and year of production, not forgetting other complicating factors or characteristics such as processing temperature and pressure, etc. The possible permutations of the multiple factors leads to what may be considered as an overwhelming selection of competing or alternative control options or sets of control parameters for a user of the domestic appliance to select from. Another problem is that users will often only learn about different control parameter options though use of the appliance by trial and error. In the case of coffee, for example, the roast style of the coffee bean has a significant impact on taste. Furthermore, the grind quality, i.e. grind size, of the coffee grounds also has a significant effect on the type, taste and quality of consumable coffee drink produced from the coffee maker appliance.

### DISCLOSURE OF INVENTION

### Technical Problem

An object of the invention is to mitigate or obviate to some degree one or more problems associated with known domestic appliances for processing consumable products.

The above object is met by the combination of features of the main claims; the sub-claims disclose further advantageous embodiments of the invention.

Another object of the invention is to provide a user of an appliance with access to knowledge from any of producers, suppliers, distributors or sellers of the consumable product.

Another object of the invention is to provide a user of an appliance with access to knowledge from other users of such appliances.

One skilled in the art will derive from the following description other objects of the invention. Therefore, the foregoing statements of object are not exhaustive and serve merely to illustrate some of the many objects of the present invention.

### Solution to Problem

### Technical Solution

In a first main aspect, the invention provides a computer implemented method of providing a set of parameters to an appliance for processing a consumable product, comprising: uploading to a network based server a set of one or more parameters for processing the consumable product, said set of parameters being stored in a network storage device in association with an identity of the consumable product and/or one or more characteristics of the consumable product; at a network connected appliance for processing a consumable product: receiving information identifying the consumable product and/or one or more characteristics of said consumable product; in response to receipt of said information at the appliance, controlling the appliance to automatically send data over said network to said server, said data comprising or relating to said received information; at said server, processing said received data to identify the consumable product and/or the identify the one or more characteristics of said consumable product; in response to said processing step, retrieving said stored set of one or more parameters from said network storage device based on the identity of the consumable product and/or the identity of the one or more characteristics of said consumable product; and sending said retrieved set of one or more parameters over said network to said appliance.

In a second main aspect, the invention provides a system for providing a set of parameters to an appliance for processing a consumable product, comprising: a network based server configured to receive an upload of a set of one or more parameters for processing the consumable product, said server being configured to store said uploaded set of parameters in a network storage device in association with an identity of the consumable product and/or one or more characteristics of the consumable product; a network connected appliance for processing a consumable product, said appliance being configured to: receive information identifying the consumable product and/or one or more characteristics of said consumable product; in response to receipt of said information at the appliance, control the appliance to automatically send data over said network to said server, said data comprising or relating to said received information; wherein said server is further configured to: process said received data to identify the consumable product and/or the identify the one or more characteristics of said consumable product; in response to said processing step, retrieve said stored set of one or more parameters from said network storage device based on the identity of the consumable product and/or the identity of the one or more characteristics of said consumable product; and send said retrieved set of one or more parameters over said network to said appliance.

In a third main aspect, the invention provides a server based method of providing a set of parameters to an appliance for processing a consumable product, comprising: receiving at the server an upload of a set of one or more parameters for processing the consumable product; storing said uploaded set of parameters in a network storage device in association with an identity of the consumable product and/or one or more characteristics of the consumable product; receiving from a network connected appliance for processing a consumable product information identifying the consumable product and/or one or more characteristics of said consumable product; processing said received data to identify the consumable product and/or the identify the one or more characteristics of said consumable product; in response to said processing step, retrieving said stored set of one or more parameters from said network storage device based on the identity of the consumable product and/or the identity of the one or more characteristics of said consumable product; and sending said retrieved set of one or more parameters over said network to said appliance.

In a fourth main aspect, the invention provides a server configured to implement the method of the third main aspect:

In a fifth main aspect, the invention provides a computer readable medium storing machine readable instructions which, when implemented on a processor of a network based server implements the steps of the method of the third main aspect of the invention.

The summary of the invention does not necessarily disclose all the features essential for defining the invention; the invention may reside in a sub-combination of the disclosed features.

### BRIEF DESCRIPTION OF DRAWINGS

### Description of Drawings

The foregoing and further features of the present invention will be apparent from the following description of preferred embodiments which are provided by way of example only in connection with the accompanying figures, of which:

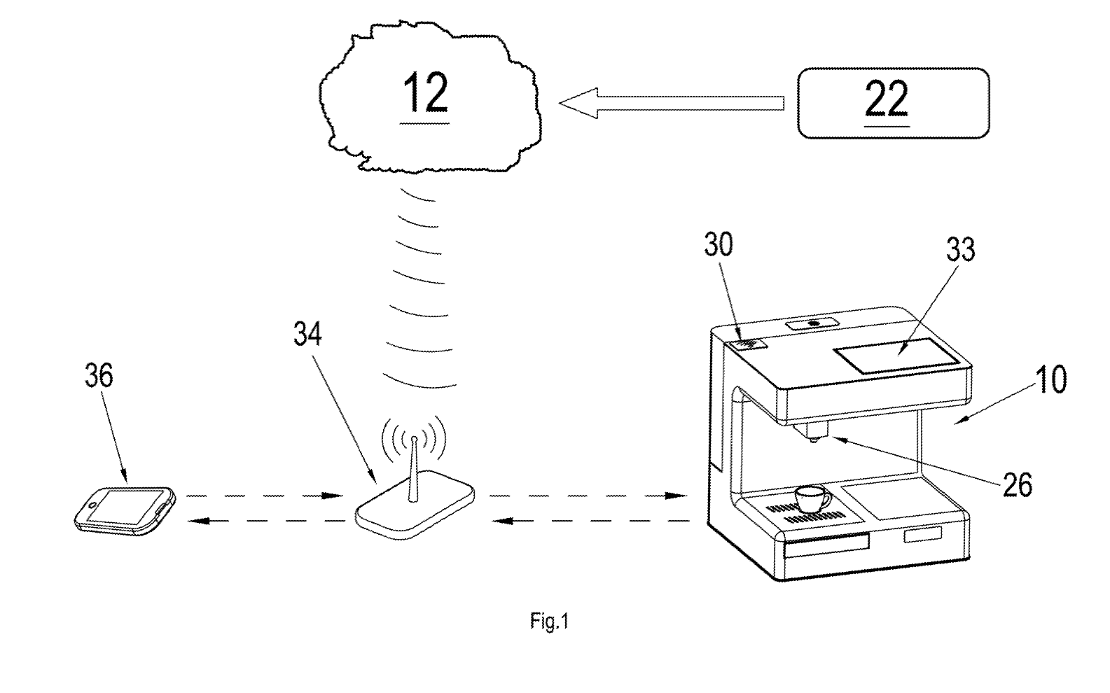

FIG. 1 is a block schematic diagram of a network connected coffee maker:

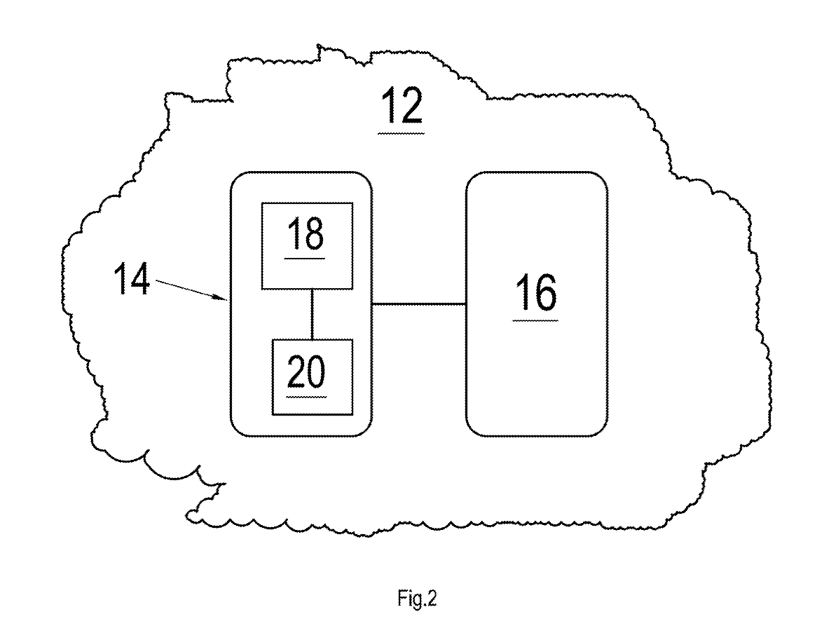

FIG. 2 is a schematic diagram of a network to which the coffee maker of FIG. 1 is connected;

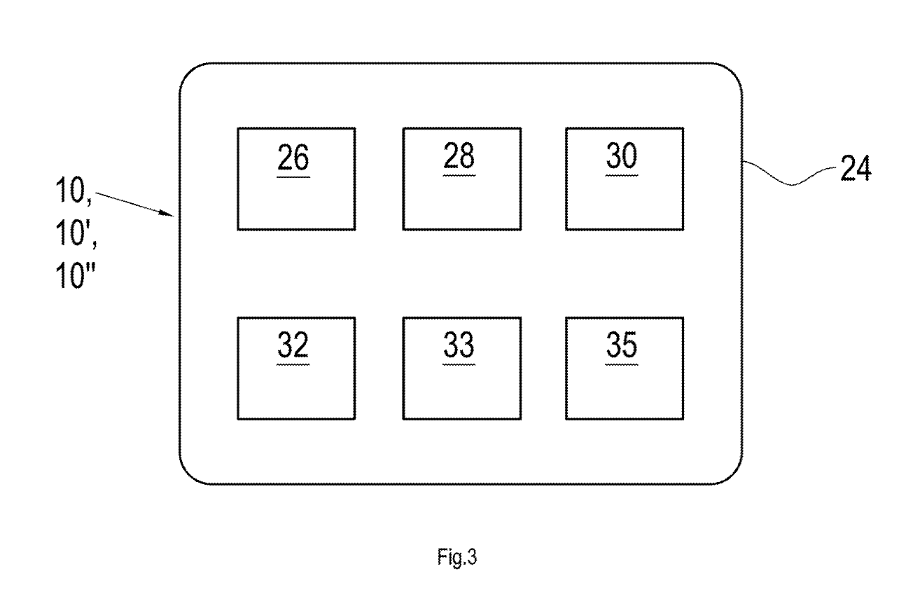

FIG. 3 is a block schematic diagram of a domestic appliance for processing a consumable product;

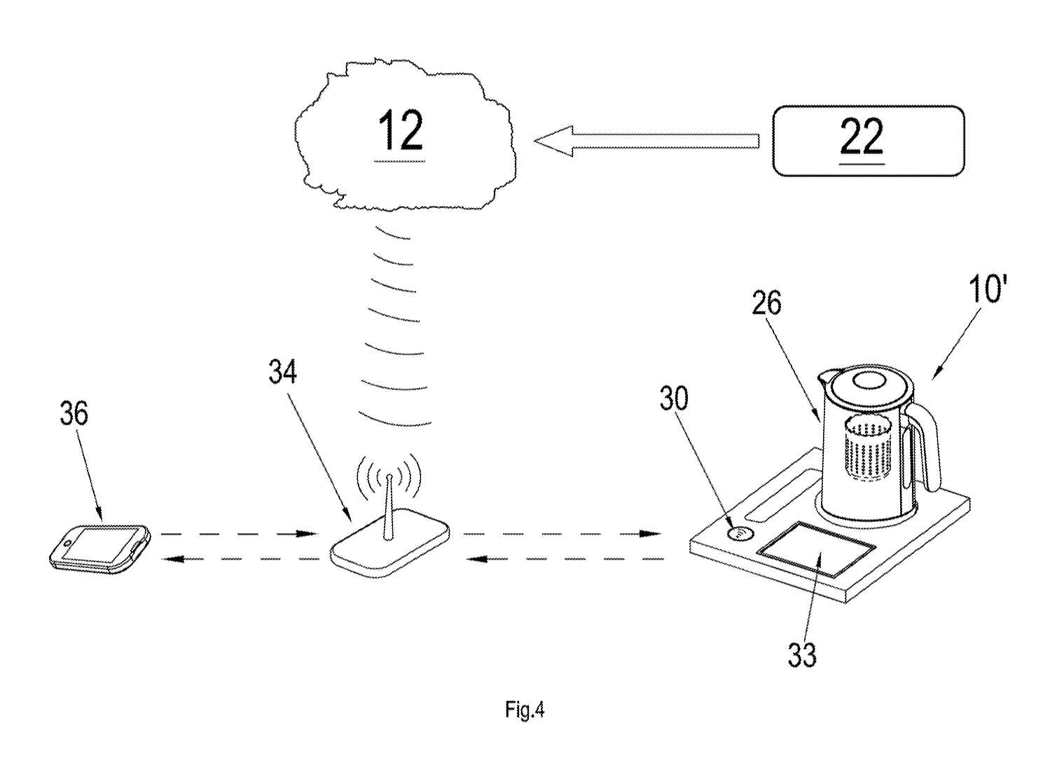

FIG. 4 is a block schematic diagram of a network connected tea maker or soup boiler; and

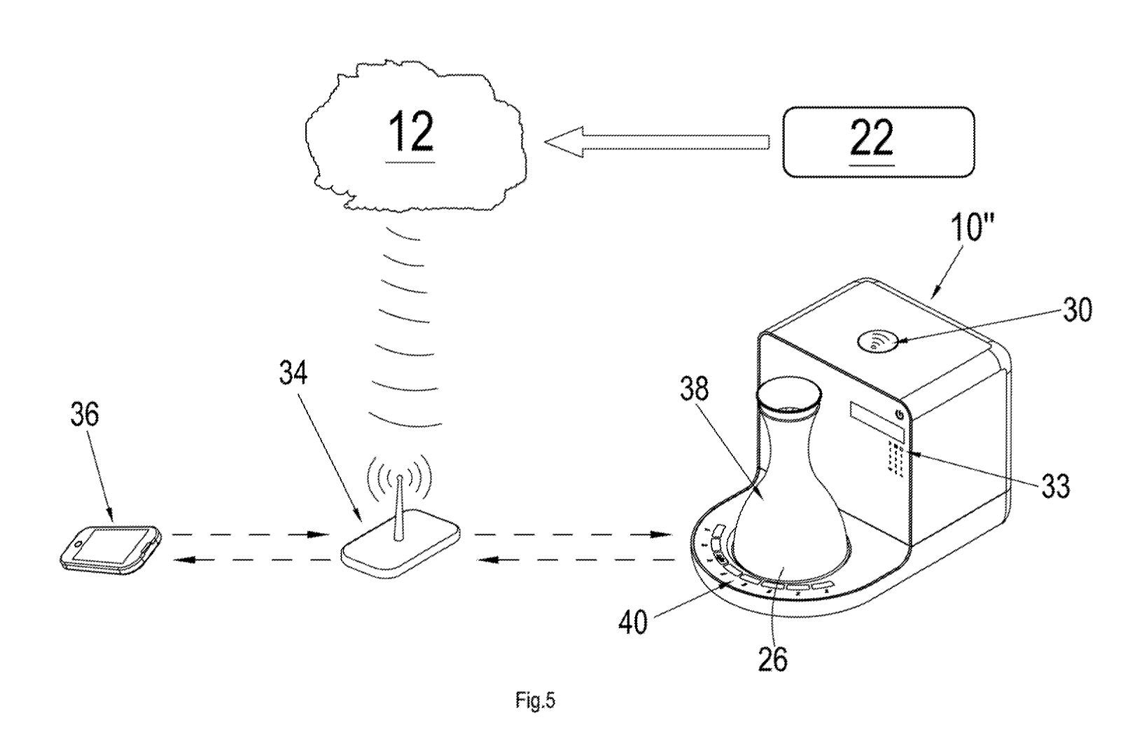

FIG. 5 is a block schematic diagram of a network connected automatic wine decanter appliance.

### MODE FOR THE INVENTION

### Mode for Invention

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

It should be understood that the elements shown in the FIGS, may be implemented in various forms of hardware, software or combinations thereof. Preferably, these elements are implemented in a combination of hardware and software on one or more appropriately programmed general-purpose devices, which may include a processor, memory and input/output interfaces.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

Referring to FIG. 1, shown is a block schematic diagram of a domestic appliance 10 for processing a consumable product in the form of a network connected coffee maker 10 for processing coffee beans or ground coffee to make a coffee drink. In the context of the invention, the term “consumable product” is taken to mean not only products which may themselves be consumed by a person or animal, but to include products which are not themselves intended for consumption by a person or animal, but from which something which is consumable is obtained. For example, coffee beans or ground coffee are not ordinarily consumed themselves, but are used to produce a coffee drink. Similarly, tea leaves are not normally intended for consumption, but a tea drink made therefrom is ingestible by a person or animal. In contrast, wine and rice are types of consumable products which are intended for direct consumption once processed, e.g. in the case of rice, once it has been cooked.

Whilst only one coffee maker 10 is shown connected to the communication network 12, it will be understood that a plurality of such appliances 10 may be connected to the network 12 and that said appliances 10 may be located in geographically diverse regions as afforded by the coverage of the network 12.

Whilst the communications network 12 preferably comprises a CLOUD network, it will be understood that the network 12 may comprise any communications network, private and/or public, which enables network enabled domestic appliances 10 to be able to communicate through the network 12 with each other, with network based devices and with other devices connected to the network 12.

As is best seen in FIG. 2, the network 12 has a network based server 14 and a database 16 under control of the server 14. The server 14 comprises at least one processor 18 and at least one memory 20. The server memory 20 stores machine code which, when executed by the processor 18, implements the methods of the invention as described herein. Whilst the database 16 is shown as a separate network based device to the server 14, it will be understood that the server 14 may host the database 16 in some embodiments. It will also be understood that the network 12 may include, in some embodiments, a plurality of network connected servers 14 and databases 16 and that these may be located at geographically diverse locations. In some embodiments, the plurality of servers 14 and databases 16 may be associated with respective third party entities.

The communications network 12 may comprise or include the public internet or may comprise a virtual private network (VPN) hosted by public communication networks such as the internet.

A third party entity device 22 is connected to the network 12. The third party entity device 22 is preferably also a network enabled coffee maker 10 of the same or a similar type to that used by a domestic user, but could comprise any network enabled device 22 which allows data to be uploaded to the server 14. The third party entity preferably comprises a producer of the consumable product—coffee beans or ground coffee in this embodiment—but may comprise any of a supplier, distributor or seller of the coffee beans or ground coffee.

Access to the network 12 may, in some embodiments, be restricted to only networked enabled coffee makers 10, 22 as herein described. Access to the network 12 may also be restricted by means of authenticating appliances 10, 22 attempting to connect to the server 14. Consequently, in some embodiments, the community of devices 10, 22 which can connect to the network 12 is restricted to coffee makers which have embedded therein suitable authentication software and suitable authentication codes to provide access to the restricted access network 12. In this way, the network 12 is restricted to a community of users of authorized appliances 12, 22 which are adapted to process a same type of consumable product.

FIG. 3 is a schematic block diagram of a domestic appliance such as a coffee maker 10. The appliance 10 comprises a housing 24 containing a consumable product processing means 26; a processor 28 for controlling the consumable product processing means to process the consumable product according to one or more control parameters to provide a product for consumption, a communications module 30 connecting said appliance 10 to the communications network 12, a memory 32 storing an application program, and at least one input interface 33 which preferably comprises a touch screen. The processor 28 is configured to execute said application program to enable said appliance 10 to exchange information through said communications network 12 with any one or any combination of the network server 14, the network database 16, or another appliance 10, 22 for processing a consumable product of a same general class of consumable product. In this embodiment, the consumable product processing means 26 comprises means for making coffee from coffee beans or ground coffee or, in some embodiments, from a powder or liquid coffee concentrate.

The appliance 10 may comprise a plurality of input devices or interfaces including a user interface, a touch screen, a camera module, a face recognition module, a voice recognition module, and a bar code or QR code scanning module. The input modules enable a user to manually or automatically input information into the appliance 10 for various functions including as content of messages to be shared with other network connected devices 10, 22 including other appliances 10 whereby users of said appliances 10 can share information. For example, the QR scanning code module may be adapted to read bar codes, QR codes or any other form of printed code on the packaging, label or the like of the consumable product in order to obtain information concerning the identity of the product and one or more of its characteristics as hereinafter described. The voice recognition module may have the dual functions of enabling a user to enter spoken information concerning a coffee product into the appliance and to recognize a specific user's voice in order that any use of the appliance is recorded for that user. In this way, the appliance 10 can offer an individual user experience to each user even though a plurality of users utilizes the same appliance. The camera module may be adapted to interoperate with the face recognition module to recognize individual users of the appliance 10 as well as to recognize information, written or pictorial, or other indicia which enable the appliance 10, either by itself or in cooperation with the server 14, to derive information about the identity of a coffee product and one or more of its characteristics.

Referring again to FIG. 1, the communications module 30 of the coffee maker may be WiFi™ enabled to allow the coffee maker 10 to connect to the network 12 via a wireless connection through a wireless router 34, but it will be understood that the coffee maker 12 may connect to the network 12 through any suitable wireless or wired means including an Ethernet connection. The coffee maker 10 may also be enabled to communicate wirelessly with handheld electronic processing devices 36 such as smart phones or tablet computers or even to communicate with personal computers (PCs) or the like (not shown) to receive and/or share other parameters or information relating to the consumable product.

One method of the invention enables third party entities such as producers, suppliers, distributors and sellers of the consumable product to upload information about the consumable product to the server 14 such that this information is accessible by users of domestic appliances such as the coffee maker 10. In order to make the information accessible to users of coffee makers 10, the information is stored by the server 14 in the database 16 in association with an identity of the coffee product and/or one or more characteristics of the coffee product. For example, an identity of the coffee product may comprise its brand name and/or the name of its manufacturer, distributor, supplier or seller. It is necessary that the identity is unique to avoid conflict between product information from different third party entities. In some embodiments, the server may be enabled to associate a unique identifier with each third party entity authorized to upload data to the network 12.

The one or more characteristics of the coffee product may comprise one or more of the type of the coffee bean or ground coffee, its roast type, its grind size, its year or date of production.

It is envisaged that each third party entity will upload a preferred or optimized set of control parameters for each permutation of its coffee products' identities and/or characteristics where said sets of preferred or optimized control parameters are preferred or optimized specifically for the coffee maker device 10. As such, it is envisaged that the third party entity will be supplied with at least one such coffee maker appliance 10 to enable said third party entity to experiment with its coffee products to derive the preferred or optimized sets of control parameters. This device may also be used by the third party entity to upload data to the server 14.

It will be understood that the number of preferred or optimized sets of control parameters received by the server 14 will grow enormously given the range of permutations of third party entities involved in the production, supply, distribution or sale of coffee products and the variations within those products from each third party entity. Furthermore, as the characteristics of many consumable products are affected by climate, growth conditions or the like, the products characteristics may change over time, e.g. by year, leading to a further escalation in the number of preferred or optimized sets of control parameters received by the server 14. Consequently, the scale of the preferred or optimized sets of control parameters is such that a user of a coffee maker 10 or similar consumable product processing appliance would have to expend considerable time in locating such information if it were not accessible in accordance with the method of the invention where such information is stored in a single network system and whereby, as will be explained below, the information can be automatically retrieved to a user's coffee maker 10 with minimal effort by a user.

It will be understood that, whilst one thrust of the invention is to facilitate the uploading of preferred or optimized sets of control parameters to the server 14 by authorized third party entities, the third party entities may be authorized to share other information relating to their products and to post advertisements and to make available product offers to users.

It will also be understood that the uploading of information is an ongoing process for the third party entities to maintain their product information and sets of control parameters current.

The control parameters for a coffee product may comprise one or more of grind size, ground coffee dose per water amount, water temperature, water pressure and time dependent on the one or more of the identity, brand, coffee bean type, roast type, coffee drink type.

A user of a coffee maker 10 may manually input information through the input interface 33 of the coffee maker 10 identifying the coffee product and/or one or more characteristics of said coffee product. Additionally or alternatively, the coffee maker 10 may be provided with a scanner or reader device 35 connected to the input interface 33 such that the coffee maker 10 can automatically recognize information relating to the coffee product from the packaging or an image of the product. The scanner 35 may comprise a bar code or Q code scanner or it may use image recognition means to compare received images of the product or its packaging with stored data relating to product images and/or packaging to thereby derive information relating to the product.

In response to manually or automatically receiving product information, the appliance 10 automatically sends data relating to said information to the server 14. The server 14, upon receiving such data, processes it to retrieve the product information and to then retrieve a preferred or optimized set of control parameters for sending to the coffee maker 10.

The step of manually inputting information relating to the coffee product or automatically recognizing information relating to the coffee product from the packaging or an image of the product may not occur entirely within the coffee maker 10. In preferred embodiments, data relating to initial product information received at the coffee maker 10 is automatically sent to the server 14 which processes the data to determine at least some of the product information which uniquely identifies the product and uses this to retrieve from the database 16 full product information which is then sent to the coffee maker 10. The received full product information (including characteristics) is displayed to the user of the coffee maker on the screen 33 and the user is invited to confirm said product information or make changes or corrections to it. In the event that the user makes changes, the step of identifying full product information may be repeated until the user confirms the displayed information. Once a user confirmation is received, the coffee maker 10 automatically sends data comprising said confirmation to the server 14 which then retrieves the preferred or optimized set of control parameters for the identified coffee product/characteristics.

The set of preferred or optimized control parameters received at the coffee maker 10 may be used to automatically control the coffee maker 10. Alternatively, the set of control parameters may be displayed to a user and the user invited to confirm the set of parameters or to make changes thereto prior to operation of the appliance 10 to make coffee. The set of control parameters, whether modified or not by the user, are stored in the memory of the coffee maker 10. The set of control parameters, whether modified or not, may be stored in association with an identity of a user of the coffee maker 10. This is desirable where a number of different users utilize the same coffee maker 10 who each may have different preferences.

Where a set of control parameters, whether modified or not, is stored in the appliance 10 in association with a unique identity and/or some unique characteristics of the coffee product, this set of control parameters can be retrieved from the memory 32 of the coffee maker 10 when next the identified user or another user inputs or presents the same coffee product information at the coffee maker 10 thereby negating the need to contact the server 14 for a preferred or optimized set of control parameters for the coffee product. Once again, the set of control parameters may be displayed to the user on the screen 33 for confirmation or modification. In the case where the subsequent user of the coffee maker 10 is another user rather than the original user then any modifications made by said another user may be stored in the memory of the coffee maker in association with said another user.

Where a user has modified a set of control parameters for a coffee product, the user's modifications, changes or adjustments to the set of control parameters may be automatically communicated by the coffee maker to the server 14 and/or to a third party entity device 22 where the third party entity is identified as being associated with the coffee product. The coffee maker 10 may also be configured to communicate such changes together with the coffee product information to a selected user of another appliance 10 or to a selected group of other users where said selection of such other user or users is provided by the user of the coffee maker appliance 10 sending the information.

The third party entity may process users' changes to the sets of preferred or optimized parameters to change or update said sets of preferred or optimized parameters.

The server 14 may be configured to run analytical software to characterize users' changes and to publish its analysis of the changes to user appliances 10. Publication may be selectively targeted at those users known to have used a particular coffee product.

The application program executed by the processor 28 of the coffee maker 10 is preferably a social networking application hosted by the server 14 which enables a user of said appliance 10 to exchange information through said communications network 12 with any one or any combination of: the server 14; a third party entity network device 22; another appliance 10; or a user selected subset of all network connected appliances 10. The social networking application also allows users of coffee makers 10 to share other information with each other which may not be related to coffee products, but the primary purpose of the social networking application is to facilitate a community having a shared interest in a particular consumable product and to share and have access to knowledge about said product in a manner which is easily accessible and efficient compared to other means of accessing information.

The coffee maker 10 may be configured to seek a user's feedback after a user has use the appliance 10 to make a coffee drink. This may comprise receiving a user's rating information for the product to be consumed and to send said rating information to any one or any combination of: the server 14; a third party entity network device 22; another appliance 10; or a user selected subset of all network connected appliances 10. The server 14 may be configured to publish rating information for coffee products and to display the (modified or updated) sets of control parameters for an identified coffee product in order of greatest ratings. In this embodiment, the server 14 may communicate a list of best rated sets of control parameters to a coffee maker appliance 10 and send the set of control parameters in response to a user's selection of one from the list of best rated sets of control parameters for a specific product.

It will be appreciated that there may be some overlap between the control parameters and the characteristics of a coffee product. For example, where a coffee maker 10 is provided with a coffee grinder to grind coffee beans into powder, one control parameter may comprise the preferred or optimized grind size which the appliance 10 should implement. In contrast, where a coffee maker does not have a grinder but is adapted to process already ground coffee, a characteristic of the coffee product for determination of a preferred or optimized set of control parameters may comprise the grind size of the coffee product the user intends to use in the appliance 10.

Referring to FIG. 4, shown is a block schematic diagram of a domestic appliance 10′ for processing a consumable product in the form of a network connected tea maker 10′ for processing tea in leaf form to make a tea drink. Whilst the primary purpose of the appliance 10′ of this embodiment is different to that of the appliance 10 of FIG. 1, the tea maker 10′ functions in largely the same manner as the coffer maker 10 and is connected to a network 12 in the same way to perform largely the same functions, but in respect of tea as a consumable product.

In the following description, like numerals are used to denote like parts to those of the embodiment of FIG. 1.

The tea maker 10′ has a structure as depicted in FIG. 3. In use, third party entities related to the production, supply, distribution or sale of tea in leaf form may be authorized to connect to the network 12 to upload data relating to their tea products including preferred or optimized sets of control parameters for controlling operation of the tea maker 10′ to brew tea. The control parameters may include initial water temperature prior to immersion of the tea leaves in the heated water, target water temperature at which immersion of the tea leaves is effected, and brewing time, etc. The characteristics of the tea may comprise tea identity/brand, standard of tea, leaf size, quality of tea, etc. In the same manner as for the coffer maker appliance 10 of FIG. 1, the tea maker appliance 10′ provides a means for a group of users to interact and share information over a social media network hosted by the server 14 and to access knowledge about the consumable product, tea, from each other and from third party entities in an easy and efficient manner.

Referring to FIG. 5, shown is a block schematic diagram of a domestic appliance 10″ for processing a consumable product in the form of a network connected automatic wine decanter appliance 10″ for oxidizing wine. Whilst the primary purpose of the appliance 10″ of this embodiment is different to that of the appliances 10, 10′ of FIGS. 1 and 4, the wine decanter appliance 10″ functions in largely the same manner as the other appliances 10, 10′ and is connected to a network 12 in the same way to perform largely the same functions, but in respect of oxidizing wine as a consumable product.

In the following description, like numerals are used to denote like parts to those of the embodiment of FIGS. 1 and 4.

The wine decanter appliance 10″ has a structure generally as depicted in FIG. 3. In use, third party entities related to the production, supply, distribution or sale of wine may be authorized to connect to the network 12 to upload data relating to their wine products including preferred or optimized sets of control parameters for controlling operation of the wine decanter 10″ to oxidize wine. The wine decanter appliance 10″ has a receptacle 38 which rests on a support plate 40 of the appliance 10″. The receptacle 38 engages with the support plate 40 so as to allow a flow of air, oxygen or oxygen enriched air to flow into the receptacle 38 and thereby through wine decanted into the receptacle 38 to oxidize the wine according to downloaded or stored control parameters.

The control parameters may include, but are not limited to: decant processing time, temperature, percentage oxygen in the decanting gas flow, and/or gas flow rate of the decanting gas.

It will be appreciated that, in the case of wine, which is partly demarcated by year of production in addition to winery, type, class or quality, the number of preferred or optimized sets of control parameters uploaded by third party entities to the server 14 may run into millions of sets. It would be difficult and very time consuming for a wine consumer to research each wine they consume to retrieve a wine producer's preferred set of control parameters for oxidizing the wine using the appliance 10″ given that, even for one wine producer, there will be a multitude of different sets of control parameters every year.

In the same manner as for the coffer maker appliance 10 of FIG. 1 and the tea maker appliance 10′ of FIG. 4, the wine decanter appliance 10″ of FIG. 5 provides a means for a group of users to interact and share information over a social media network hosted by the server 14 and to access knowledge about the consumable product, tea, from each other and from third party entities in an easy and efficient manner.

In another aspect of the invention, the data collected in the server 14 about users, their tastes and/or preferences may be provided under license, subscription or some other condition for use by the third party entities on improving their products, targeted marketing of their products, educating users on their products, or generally advertising their products. The server 14 may collect data about each user of an appliance 10 charting their product consumption habits, their product preferences, and/or their usage of the appliance 10 and make this data available to third party entities for targeted marketing of their products, education about their products, providing users with recommended product packages or recommended product recipes or blends, or generally advertising their products. The server 14 may be configured to ‘sniff’ data about users' product consumption habits, product preferences, and/or usage of the appliance 10 from social media message exchanges between users and/or from other messages or requests sent by the users to the server 14. Where the server 14 is configured to host a shopping channel to enable users to purchase consumable products, the server 14 again maintains data relating to the users' purchases as part of the data records for said users.

In another aspect of the invention, third party entities may be permitted to host any of their own: online workshops, chat rooms, blogs, forums, webinars, etc. concerning their products. Data collected from these activities is shared with the server 14 to enhance its data records for the users.

In general, the invention provides a computer implemented method and system for providing a set of parameters, for example operational control parameters, to a domestic appliance for controlling operation of the appliance when processing a consumable product such as coffee, tea, wine, rice or the like. The method comprises uploading to a network based server from a third party entity such as a producer, supplier, distributor or seller of a consumable product an optimized or preferred set of one or more control parameters for processing the consumable product based on its identity and/or one or more specified characteristics of the product. The set of parameters is stored in a network storage device such as a database under control of the server. The set of parameters is stored in association with its identity and/or one or more specified characteristics. At a network connected appliance for processing a consumable product, the method includes receiving information identifying the consumable product and/or one or more characteristics of said consumable product. In response to receipt of said information at the appliance, the appliance is controlled to automatically send data over said network to said server. At the server, the data is processed to identify the consumable product and/or the identify the one or more characteristics of said consumable product and, in response, to retrieve said stored set of one or more parameters from said network storage device and send them over said network to said appliance.

1-27. (canceled)

28: A computer implemented method of providing a set of parameters to an appliance for processing a consumable product, comprising:
uploading to a network based server a set of one or more parameters for processing the consumable product, said set of parameters being stored in a network storage device in association with an identity of the consumable product and/or one or more characteristics of the consumable product;
at a network connected appliance for processing a consumable product:
receiving information identifying the consumable product and/or one or more characteristics of said consumable product;
in response to receipt of said information at the appliance, controlling the appliance to automatically send data over said network to said server, said data comprising or relating to said received information;
at said server:
processing said received data to identify the consumable product and/or the identify the one or more characteristics of said consumable product;
in response to said processing step, retrieving said stored set of one or more parameters from said network storage device based on the identity of the consumable product and/or the identity of the one or more characteristics of said consumable product; and
sending said retrieved set of one or more parameters over said network to said appliance.

29: The method of claim 28, wherein the step of uploading comprises uploading said set of one or more parameters from a network device of a third party entity associated with production, supply, distributorship and/or sale of the consumable product.

30: The method of claim 29, wherein said network device of said third party entity comprises a network connected appliance for processing a consumable product of a type similar or the same type of appliance as that used by a consumer of the consumable product.

31: The method of claim 28, wherein the set of one or more parameters comprises one or more control parameters for controlling operation of the appliance to process the consumable product.

32: The method of claim 29, wherein the set of one or more parameters comprises one or more control parameters determined by the third party entity as an optimum or preferred set of control parameters for controlling operation of the appliance to process the consumable product, said set of optimized or preferred control parameters being determined by the entity for a specified identity of the consumable product and/or a set of one or more specified characteristics of the consumable product and wherein said entity uploads said optimized or preferred control parameters to said server in association with said specified identity of the consumable product and/or said set of one or more specified characteristics of the consumable product.

33: The method of claim 28 wherein the server stores a plurality of sets of one or more parameters for processing the consumable product, each set of parameters being stored in the network storage device in association with a respective identity of the consumable product and/or one or more characteristics of the consumable product.

34: The method of claim 33, wherein the server provides authenticated access to the server to a plurality of third party entities associated with production, supply, distributorship and/or sale of the consumable product to enable each of said entities to respectively upload sets of one or more parameters for processing the consumable product, each set of parameters being stored in the network storage device in association with an identity of the consumable product and/or one or more characteristics of the consumable product.

35: The method of claim 28, further comprising the step of controlling the appliance to exchange information through said network with any one or any combination of: the server; a third party entity device; or another appliance for processing a consumable product of a same general class of consumable product.

36: The method of claim 35, further comprising the steps of:
using a processor to control the appliance to process the consumable product according to a set of one or more control parameters to provide a product for consumption;
connecting said appliance to said network using a communications module;
storing in a memory an application program; and
executing said application program on said processor to enable said appliance to exchange information through said network.

37: The method of claim 28, wherein it comprises receiving through a user interface a user's changes, adjustments or modifications of any one or more of the parameters of a set of one or more parameters.

38: The method of claim 37, wherein it comprises storing any user changes, adjustments or modifications to any one or more of the parameters of the set of parameters such that, when the same user uses the appliance for processing the consumable product on a subsequent occasion, the appliance implements the changed, adjusted or modified set of parameters.

39: The method of claim 37, wherein it comprises storing said user changes, adjustments or modifications to any one or more of the set of parameters in association with a type of consumable product, a brand of the consumable product; and/or one or more characteristics of the consumable product.

40: The method of claim 37, wherein it comprises storing said user changes, adjustments or modifications to any one of the one or more of the set of parameters in association with a specified user of the appliance.

41: The method of claim 37, wherein it comprises sending any user changes, adjustments or modifications to any one or more of the set of parameters to any one or any combination of: the server; a third party entity network device; another appliance; or a user selected subset of all network connected appliances.

42: The method of claim 28, wherein it comprises receiving a user's rating information for the product to be consumed where said product is processed according to a set of parameters and to send said rating information to any one or any combination of: the server; a third party entity network device; another appliance; or a user selected subset of all network connected appliances.

43: The method of claim 28, wherein the application program executed by said processor is a social networking application which enables a user to of said appliance to exchange information through said communications network with any one or any combination of: the server; a third party entity network device; another appliance; or a user selected subset of all network connected appliances.

44: The method of claim 28, wherein the appliance comprises a coffee maker, a tea maker, an automatic wine decanter, a soup boiler or a rice cooker.

45: The method of claim 28, wherein access to the network is restricted to appliances for processing a same type of consumable product.

46: A system for providing a set of parameters to an appliance for processing a consumable product, comprising:
a network based server configured to receive an upload of a set of one or more parameters for processing the consumable product, said server being configured to store said uploaded set of parameters in a network storage device in association with an identity of the consumable product and/or one or more characteristics of the consumable product;
a network connected appliance for processing a consumable product, said appliance being configured to:
receive information identifying the consumable product and/or one or more characteristics of said consumable product;
in response to receipt of said information at the appliance, control the appliance to automatically send data over said network to said server, said data comprising or relating to said received information;
wherein said server is further configured to:
process said received data to identify the consumable product and/or the identify the one or more characteristics of said consumable product;
in response to said processing step, retrieve said stored set of one or more parameters from said network storage device based on the identity of the consumable product and/or the identity of the one or more characteristics of said consumable product; and
send said retrieved set of one or more parameters over said network to said appliance.

47: A server based method of providing a set of parameters to an appliance for processing a consumable product, comprising:
receiving at the server an upload of a set of one or more parameters for processing the consumable product;
storing said uploaded set of parameters in a network storage device in association with an identity of the consumable product and/or one or more characteristics of the consumable product;
receiving from a network connected appliance for processing a consumable product information identifying the consumable product and/or one or more characteristics of said consumable product;
processing said received data to identify the consumable product and/or the identify the one or more characteristics of said consumable product;
in response to said processing step, retrieving said stored set of one or more parameters from said network storage device based on the identity of the consumable product and/or the identity of the one or more characteristics of said consumable product; and
sending said retrieved set of one or more parameters over said network to said appliance.
